(19) United States
(12) Patent Application Publication
(10) Pub. No.: US 2014/0148211 A1
(43) Pub. Date: May 29, 2014

(54) ADAPTIVE LAYER SELECTION BY POWER LIMITED DEVICE

(71) Applicant: AT&T MOBILITY II LLC, Atlanta, GA (US)

(72) Inventors: Richard J. Mountford, Millersville, MD (US); Arthur Richard Brisebois, Cumming, GA (US); Thomas Hesselschwerdt, Fort Wayne, IN (US); Haywood Peitzer, Randolph, NJ (US)

(73) Assignee: AT&T MOBILITY II LLC, Atlanta, GA (US)

(21) Appl. No.: 13/686,871

(22) Filed: Nov. 27, 2012

(51) Int. Cl. H04W 52/44

(52) U.S. Cl. CPC H04W 52/44
USPC 455/522

(57) ABSTRACT

Adaptive layer selection by a power limited device is provided by reducing a transmit power level of a mobile device by a predefined value as a result of detecting an event associated with a change to the transmit power level. A received signal level of a signal received from a network element is measured as signal level data. The signal level data representing the received signal level is modified based on the predefined value to obtain modified signal level data representing the received signal level as modified. The modified signal level data is reported to the network element.

### TECHNICAL FIELD

The subject disclosure relates to wireless communications and, also generally, to the adaptive layer selection by a power limited device.

### BACKGROUND

The wide adoption of mobile devices along with ubiquitous cellular data coverage has resulted in an explosive growth of mobile applications that expect always-accessible wireless networking. This explosion has placed strains on resources that are scarce in the mobile world. On the user side, dropped calls and poor communication have been blamed for user dissatisfaction. On the network side, instances of dropped calls and poor communication can occur due to a reduction in mobile device output power, which can be implemented in order to comply with specific absorption rate values.

### BRIEF DESCRIPTION OF THE DRAWINGS

Various non-limiting embodiments are further described with reference to the accompanying drawings in which:

FIG. 1 illustrates an example, non-limiting system configured to perform adaptive layer selection, according to an aspect;

FIG. 2 illustrates an example, non-limiting system configured to facilitate adaptive layer selection by power limited user equipment, according to an aspect;

FIG. 3 illustrates an example, non-limiting wireless communications environment configured to consider uplink power limitations to mitigate communication failures, according to an aspect;

FIG. 4 illustrates a chart showing a comparison between a measured reference signal received power level and a reported reference signal received power level, according to an aspect;

FIG. 5 illustrates an example, non-limiting system that employs an artificial intelligence component, which can facilitate automating one or more features in accordance with the disclosed aspects;

FIG. 6 illustrates an example, non-limiting method for adaptive layer selection by a power limited device, according to an aspect;

FIG. 7 illustrates an example, non-limiting method for considering uplink power limitations to mitigate communication failures, according to an aspect;

FIG. 8 is a schematic example wireless environment that can operate in accordance with aspects described herein;

FIG. 9 illustrates a block diagram of access equipment and/or software related to access of a network, in accordance with an embodiment; and

FIG. 10 illustrates a block diagram of a computing system, in accordance with an embodiment.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

Mobile devices or user equipment (UE) transmit and receive radio signals to support bi-directional wireless service. For example, a UE receives communications from a network (e.g., base station, eNB, radio network, and so forth) over a downlink and sends a communication to the network over an uplink. Usage of a high (e.g., maximum, near maximum) UE transmit power and receive sensitivity can deliver better wireless range and performance compared to a lower (e.g., less than maximum) mobile device transmit power and receive sensitivity. In the transmit (uplink) direction, UE radiation should stay within limits that have been determined to be safe for absorption by the human body. Therefore, device manufacturers attempt to strike a balance between wireless performance and safety, such as in accordance with pertinent regulations.

The radiation limits determined to be safe for human absorption are referred to as a specific absorption rate (SAR) value, which can be dependent upon a number of factors. These factors can include the geometry of the body part exposed to the RF (Radio Frequency) energy and the exact location and geometry of the RF source relative to the body part. Further, the factors can include the amount of power radiating from the RF source and the frequency-specific transmission loss between the RF source and the body part.

Instead of limiting UE power and performance based on a worst-case SAR, UE manufacturers might use proximity sensors and transmit power limits to dynamically detect, predict, and limit actual SAR. UE power can therefore be limited when and where body parts are detected nearby. When no body parts are detected nearby, the UE power can be at full (or near full) power.

UE power management based on proximity sensors and SAR conformance can provide benefits with respect to the performance versus SAR tradeoff perspective. However, limitations in downlink-centric layer selection mechanisms in the UE and network are exposed. The effective coverage and service area for any bi-directional wireless technology is only as good as the weakest link, whether on the uplink or on the downlink. Therefore, a UE should select a technology and/or frequency layer with a best uplink and downlink balance (or should at least select the layer with the “best weakest link”).

Various mobility mechanisms trigger handover and reselection. For example, the handover and reselection can be from one technology/frequency layer towards another technology/frequency layer. Such handover and reselection can be based upon downlink measurements only. In another example, selection towards or away from technology/frequency layers can be triggered when raw downlink signal strength satisfies an absolute or relative criterion. When UE power is full, the uplink service is roughly equivalent to the downlink service, thus the handover and reselection based on downlink measurements only can be effective during full power situations.

However, when UE power is reduced, such as due to limiting the SAR based on proximity sensing, downlink-only selection can amplify the negative performance effects of UE power reduction. Further, the radio network might be completely unaware of the UE power reduction and, therefore, bidirectional calls may drop when uplink limits are reached, regardless of the downlink strength. Further, measurement-based mobility could also fail if the UE power is reduced and the measurement reports are not received by the base station.

Other frequency/technology layers (e.g., with less SAR risk) may allow more UE power, uplink coverage, and reliability. However, these considerations are disregarded due to the downlink-only layer selection technique.

The various aspects disclosed herein allow the UE to weigh frequency/technology layer selection, reselection, and/or active mode mobility in accordance with uplink transmit power limitations. According to some aspects, adjustments can be made based on various considerations, which can include, but are not limited to, frequency attenuation table(s) and/or modified mobility criterion and mobility action.

It is noted that although various aspects and embodiments are discussed herein with respect to UMTS and/or LTE, the disclosed aspects are not limited to a UMTS implementation and/or an LTE implementation. For example, aspects or features of the disclosed embodiments can be exploited in substantially any wireless communication technology. Such wireless communication technologies can include Universal Mobile Telecommunications System (UMTS), Code Division Multiple Access (CDMA), Wi-Fi, Worldwide Interoperability for Microwave Access (WiMAX), General Packet Radio Service (GPRS), Enhanced GPRS, Third Generation Partnership Project (3GPP) Long Term Evolution (LTE), Third Generation Partnership Project 2 (3GPP2) Ultra Mobile Broadband (UMB), High Speed Packet Access (HSPA), Evolved High Speed Packet Access (HSPA+), High-Speed Downlink Packet Access (HSDPA), High-Speed Uplink Packet Access (HSUPA), Zigbee, or another IEEE 802.XX technology. Additionally, substantially all aspects disclosed herein can be exploited in legacy telecommunication technologies.

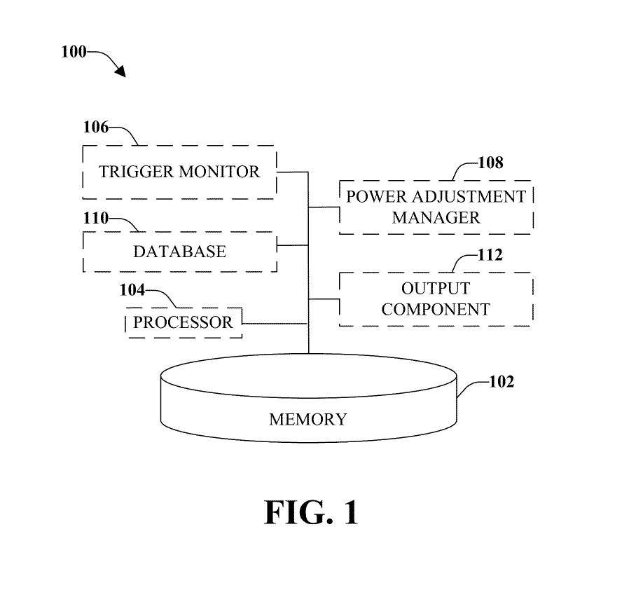

Referring initially to FIG. 1, illustrated is an example, non-limiting system 100 configured to perform adaptive layer selection, according to an aspect. System 100 can be configured to compensate for uplink transmit power limitations. For example, if an uplink transmit power level needs to be reduced, one or more reported mobility measurements can be reduced by a similar amount in order to compensate for the reduction in the uplink transmit power. System 100 can be implemented in a UE, for example.

Included in system 100 can be at least one memory 102 that can store computer executable components and instructions. System 100 can also include at least one processor 104, communicatively coupled to the at least one memory 102. Coupling can include various communications including, but not limited to, direct communications, indirect communications, wired communications, and/or wireless communications. The at least one processor 104 can facilitate execution of the computer executable components stored in the memory 102. The at least one processor 104 can be directly involved in the execution of the computer executable component(s), according to an aspect. Additionally or alternatively, the at least one processor 104 can be indirectly involved in the execution of the computer executable component(s). For example, the at least one processor 104 can direct one or more components to perform the operations.

It is noted that although one or more computer executable components may be described herein and illustrated as components separate from memory 102 (e.g., operatively connected to memory), in accordance with various embodiments, the one or more computer executable components could be stored in the memory 102. Further, while various components have been illustrated as separate components, it will be appreciated that multiple components can be implemented as a single component, or a single component can be implemented as multiple components, without departing from example embodiments.

System 100 can include a trigger monitor 106 that can be configured to detect various situations that can prompt the need for a transmit power (also referred to as an output power or uplink power) to be reduced. For example, a situation that can be detected by the trigger monitor 106 can be the proximity of a object, such as a body. However, other situations can prompt the need for reduction of the transmit power and the disclosed aspects are not limited to the detection of a body or another object in proximity to the UE. For example, the body can have human characteristics.

When trigger monitor 106 detects a situation that prompts a reduction in the transmit power, a power adjustment manager 108 is notified. The power adjustment manager 108 can be configured to reduce the transmit power by a predefined value. For example, the amount that the transmit power is reduced can be a function of a type of radio access technology being utilized by the UE and a frequency band in which the UE is determined to be operating. In an implementation, a frequency attenuation table, which can be stored in a database 110, can be accessed by the power adjustment manager 108 in order to determine the amount that the transmit output power should be reduced.

The power adjustment manager 108 can also be configured to modify mobility criterion in response to the situation and based on the predefined value. In an implementation, the power adjustment manager 108 can be configured to modify the mobility criterion according to the proximity detection and the frequency attenuation table. For example, if the transmit power is reduced by 15 dB upon the detection of an event (e.g., detected by trigger monitor 106), the power adjustment manager 108 can reduce a reported mobility measurement by 15 dB.

The modified criterion can be applied to absolute and relative measurements used for mobility. For example, the modified criterion can be applied for selection from a first frequency technology layer to a second frequency technology layer. However, according to an implementation, the modified criterion is not applied to non-mobility measurements. For example, the modified criterion is not applied to open loop power control.

In an implementation, the frequency attenuation table and pertinent adjustments are applied to reported mobility measurements but might not be used for non-mobility measurements. For example, the frequency attenuation table and adjustments might not be used for measurements that include, but are not limited to, Channel Quality Indicator (CQI) reporting and Reference Signal Received Quality (RSRQ) reporting.

When in the active mode, the base station (eNB in LTE) informs the UE the served downlink signal strength (Reference Signal Received Power (RSRP) in LTE) should trigger measurements and measurement reports towards other frequency/technology layers. For measurement-based mobility (gap-assisted inter-frequency Radio Access Technology (RAT) mobility in LTE) the base station also provides absolute and relative threshold and hysteresis, which can be a margin for the UE to use when selecting other frequency/technology layers. The power adjustment manager 108 can be configured to adjust each of these measurement criterion. In an implementation, the power adjustment manager 108 adjusts these values by the predefined value (e.g., the value by which the output transmit power was reduced). For example, the power adjustment manager 108 can adjust these values according to the frequency attenuation table. The adjustment is configured to penalize the frequency/technology layers for which UE power is limited and, thereby, the adjustment is configured to prefer frequency/technology layers for which UE power is not limited.

The output component 112 is configured to convey the adjusted reported measurements to a base station (or radio network). For example, the UE receives a signal from the base station at a level of −105 dB. Due to the detection of a triggering event, the transmit power was reduced by 5 dB. Therefore, power adjustment manager will subtract 5 dB from the −105 dB measurement and the output component 112 will report the received signal measurement as −110 dB. This artificially makes the signal appear worse than it actually is and can help to compensate for the reduced transmit power (e.g., forcing a handoff to a different technology/frequency band).

According to the various aspects, the limitation of the transmit power can be overcome or compensated for since the UE is aware that the operation is at a reduced transmit power. The base station is not aware that the UE is transmitting at a reduced power level. Further, if a triggering event does not occur (e.g., the transmit power is not reduced), the UE can transmit at maximum power and there is no need for the power adjustment manager 108 to adjust the reported mobility measurements.

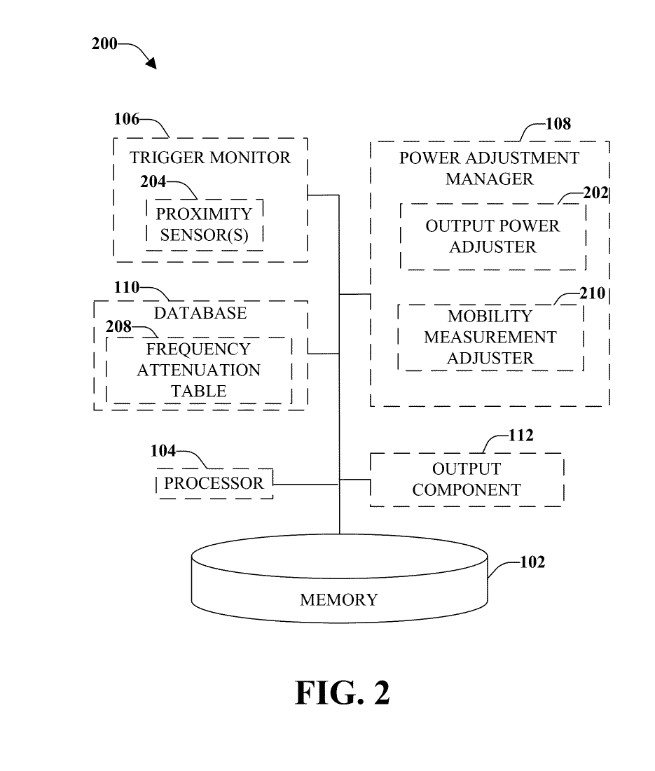

FIG. 2 illustrates an example, non-limiting system 200 configured to facilitate adaptive layer selection by a power limited user equipment, according to an aspect. System 200 can include an output power adjuster 202 that can be configured to modify the output power when a triggering event occurs (e.g., as detected by the trigger monitor 106). The adjustment to the output power can be a downward modification to the output power value. For example, if a maximum or normal operating output power is 15 dB and the value by which the output power is to be modified is 3 dB, the output power is changed, by the output power adjuster 202, to 12 dB.

According to an implementation, at least one proximity sensor 204 can be operatively coupled to system 200. The proximity sensor 204 can be configured to detect the presence of an object in close proximity to the UE. In a large number of cases, the object sensed is a body. Therefore, according to various regulations, the output power of the UE is reduced in accordance with various guidelines (e.g., FCC (Federal Communications Commission) and EU (European Union) SAR Exposure Limits).

In view of this, UE manufacturers can perform various tests, such as an exposure text, and determine the attenuation needed to comply with the SAR exposure limits for each technology and frequency band. After the attenuation is known, the appropriate values for each technology and frequency band can stored in the UE, which is used by the power adjustment manager 108 to reduce the transmit power value.

In an implementation, the values can be stored, such as in the database 110, as a frequency attenuation table 208. It is noted that a database can include volatile memory or nonvolatile memory, or can include both volatile memory and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which can operate as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory (e.g., data stores, databases, and so on) of the various disclosed aspects is intended to comprise, without being limited to, these and any other suitable types of memory.

As discussed, the frequency attenuation table 208 can be predefined and stored in the device. For example, prior to type acceptance, SAR can be measured for each device, proximity position, and frequency/technology band at full power. The results of the measurement can indicate which position and frequency/technology band causes excess SAR and by how much. In order to gain type approval, the UE manufacturer can automatically limit UE power for position, frequency/technology band combinations that otherwise exceed SAR requirements. Based upon these test results, the UE manufacturer can create an attenuation table (e.g., frequency attenuation table 208) for each UE.

Table 1 below illustrates an example frequency attenuation table.

TABLE 1

| Frequency/ | non-proximity | proximity |
|---|---|---|
| Technology | attenuation | attenuation |
| LTE 700 | 0 dB | 6 dB |
| LTE AWS | 0 dB | 3 dB |
| LTE 850 | 0 dB | 6 dB |
| LTE 1900 | 0 dB | 0 dB |
| UMTS 850 | 0 dB | 6 dB |
| UMTS 1900 | 0 dB | 0 dB |

In the example frequency attenuation table (Table 1), for LTE 700, the UE transmit power is full when away from the body (e.g., non-proximity attenuation) and reduced by 6 dB when near the body (e.g., proximity attenuation). In another example for LTE AWS according to Table 1, the UE transmit power is full when away from the body and reduced by 3 dB when near the body.

Based on the amount that the output power adjuster 202 modifies the output power, a mobility measurement adjuster 210 can be configured to change a value of a measured power level by a similar amount, wherein the changed value can be used for reporting the measurement to the base station. For example, the measured downlink power level can be artificially reduced such that the UE appears to be further away from the base station than it really is. The reported (artificial) measurement might cause the UE to move to a different network (e.g., both the base station and the UE use the penalized level to perform various mobility functions and make mobility determinations). When the UE moves to the target network, which might be a different frequency band and technology than the source network, a different compensation factor, specific to the target network frequency band and technology, is applied. Similar measurements, reductions, and reporting are performed.

Following are some examples of the modification to the reported measuring using Table 1. In an active mode example, a UE is served by 700 LTE. The LTE 700 IRAT/Inter-frequency measurement threshold (A2) is −117 dBM. In a non-trigger (or non-proximity) case, the UE measures and forwards (e.g., though output component 112) a measurement report to eNB when the downlink RSRP falls below −111 dBm. In the LTE case, after receiving the measurement reports, the eNB can send a release and redirect command, which forces the UE towards another frequency/technology layer. If a trigger event (e.g., proximity case) occurs, the measurements and measurement reports can occur 6 dB sooner since the UE reduces the measurements by 6 dB (for this example). Upon receipt of the report, the eNB can cause the UE to exit earlier from LTE 700 when the UE power is limited.

In the idle mode, the base state (or eNB) broadcasts system information, which informs the UE that served downlink signal strength (or RSRP) should trigger scan measurements and reselection toward other frequency/technology layers. In some frequency/technology combinations the base station can also provide absolute and relative thresholds and hysteresis/margin for the UE to use when selecting other frequency/technology layers. Each of these measurement criterion should be adjusted by the UE according to the frequency attenuation table.

In an idle mode example, a UE is served by 700 LTE and the LTE IRAT/Inter-frequency scan threshold is −116 dBm. The UMTS 1900 minimum signal strength for reselection is −110 dBm. The UMTS 850 minimum single strength for reselection is −110 dBm. Further, the UMTS (850 or 1900) SIB 19 (return to LTE) threshold for LTE 700 is −110 dBm.

Continuing the idle mode example, for a non-proximity case, the UE scans UMTS 850 and 1900 when downlink RSRP falls below −116 dBM. The UE selects MTS 850 if downlink RSCP is above −110 dBM. If the downlink RSRP is above −110 dBM, the UE can return to LTE 700.

For a proximity situation using the above example, there is a 6 dB adjustment for LTE 700 and UMTS 850; there is no adjustment for UMTS 1900. The UE scans UMTS 850 and 1900 when downlink RSRP falls below −110 dBm. The UE selects UMTS 850 if downlink RSCP is above −104 dBM. If the downlink RSCP is above −110 dBM, the UE selects UMTS 1900. If the downlink RSRP is above −104 dBM, the UE returns to LTE 700.

As noted in the example, for the proximity case, idle mode scan from LTE 700 occurs 6 dB sooner. In this case UMTS 1900 is favored by 6 dB over UMTS 850. Further, the return to LTE 700 occurs 6 dB later.

It is noted that although these examples pertain to LTE and UMTS IRAT mobility, the disclosed aspects can be applied to other frequency/technology combinations. For example, the disclosed aspects can apply to, but are not limited to, inter-frequency LTE and GSM. Application of the disclosed aspects to other frequency/technology combinations can be applied in a similar manner as discussed herein. For example, the UE can make adjustments prior to measurement reports or reselection towards the radio network frequency/technology. These adjustments can be transparent to (and necessitate no changes by) the radio network.

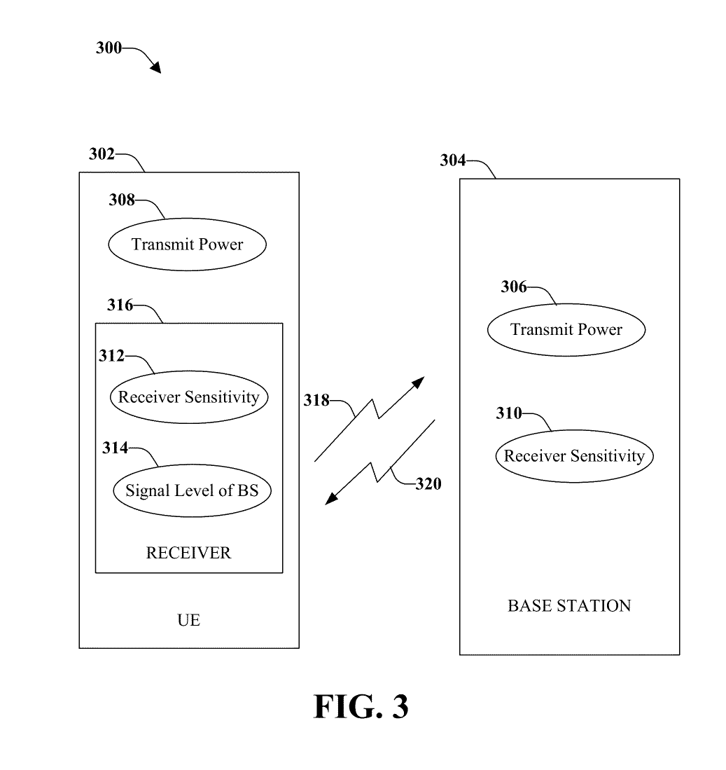

FIG. 3 illustrates an example, non-limiting wireless communications environment 300 configured to consider uplink power limitations to mitigate communication failures, according to an aspect. Wireless communications environment 300 can include a mobile device, referred to herein as a user equipment or UE 302 and a base station 304, however, it is understood that a wireless communications environment 300 can include more than one UE and more than one base station and a single mobile device and a single base station are discussed herein for purposes of simplicity.

The disclosed aspects can automate a UE 302 such that uplink power limitations are considered in various idle and active mode layer/technology selection processes. This can preserve calls, which are otherwise prone to uplink failure and call drop. The disclosed aspects can be implemented in the UE, can be applied in idle mode, and are transparent to the radio network and associated nodes.

In order to comply with FCC and EU SAR exposure limits, UE manufactures may employ techniques that would restrict the transmit output power of their devices below the maximum allowed transmit output power levels defined by 3GPP. According to an implementation, UE manufacturers employ a technique that detects proximity to a fixed object (e.g., a body) and, if proximity is detected, the UE will restrict the transmit output power of the UE below its maximum allowed value.

Generally, communication networks are designed for devices that operate at full power and, if there is a reduction in the transmit power, communication failures, including dropped calls, can occur. In some situations (e.g., to comply with FCC and EU SAR exposure limits), the output power of a UE is reduced. To help mitigate issues associated with the UE operating in reduced power modes, and without needing to modify the network configuration, the disclosed aspects are configured to allow the UE to be slightly smarter about its selection of an appropriate serving cell.

When the UE reduces its power, there is no notification back towards the network. Thus, there is nothing that the network can do to adapt or adjust to the UE with reduced power. The disclosed aspects provide for the UE to make adjustments during a power limited situation so that the UE is not spending needless time on a frequency carrier for which power is reduced, when it could otherwise handoff to a different carrier that does not have the power limitations.

The amount of power by which a UE is limited varies depending upon a technology determined to be employed by the UE and a frequency band with which the UE communicates with a network associated with operation of the UE and, in some cases, can be in accordance with SAR exposure limits. For example, if a UE is operating in WCDMA at 850 MHz, the UE will reduce its output power by an amount appropriate for that technology and frequency band. The amount by which power is reduced can differ as the UE moves into LTE and a different frequency band.

Wireless communications networks are designed around an RF Link Budget, which ensures a balanced bi-direction path loss between the UE 302 and the base station 304. Elements of the link budget equation are (a) base station transmit power 306; (b) UE transmit power 308; (c) base station receiver sensitivity 310; and (d) UE receiver sensitivity 312. By reducing the transmit power of a UE below the value of the UE transmit power used in the design of the wireless communications network, the RF link budget might no longer support a balanced RF communications path between the UE and the base station, effectively decreasing the effective radius of the cell.

The disclosed aspects help to ensure a balanced RF communications path between the UE 302 and the base station 304 is maintained. For example, if the UE transmit power 308 is reduced by an amount “X’, this reduction is compensated for in another factor of the RF link budget equation. In this case, that factor is the signal level 314 of the base station 304 measured by a UE receiver 316 and reported by the UE 302 back to the base station 304 in order to help ensure that the UE is receiving service from the most efficient cell. However, in the case where the UE output power is being restricted, the cell currently serving the UE may no longer be the most efficient cell.

Therefore, since the measurement for the uplink path 318 has been reduced by an amount “X”, in order to maintain a balanced bi-direction path, the measurement for the downlink path 320 is also reduced by the same amount “X”, according to the disclosed aspects. This can be achieved by subtracting amount “X” from the downlink receive level (e.g., signal level 314). In an implementation, if the UE is employing the technique for transmit output power restriction, the UE would consider all (mobility) measurements made by its receiver 316 to be “X” dB less than the measured level.

Since the maximum allowed UE transmit power can vary depending on both frequency band and technology employed, UE manufacturers can restrict UE output power by differing amounts, which can depend on both frequency band and technology in order the comply with SAR exposure limits. Consequently, the compensation factor “X” can vary and would also be taken into account by the UE such that measurements made either in different frequency bands or different technologies would have the appropriate factor applied.

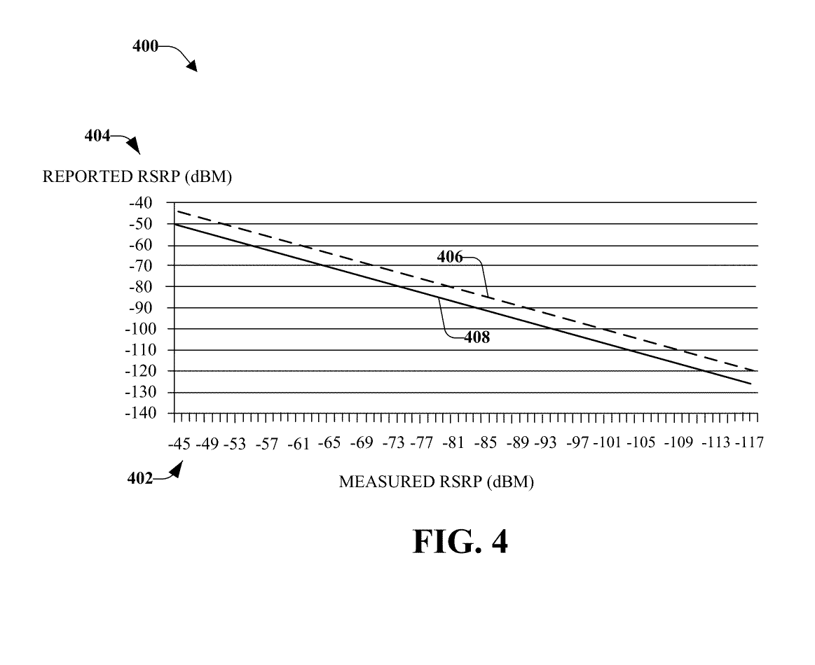

By way of example and not limitation, the technology is EUTRAN. The maximum allowed UE transmit power without proximity restriction is +23 dBM and the maximum allowed UE transmit power with proximity restriction is +17 dBM. Thus, the compensation factor “X” is 23 minus 17, which equals 6 dB (23−17=6). The downlink measured signal level is referred to as RSRP, in dBm. This example compensation factor is illustrated in FIG. 4, which illustrates a chart 400 showing a comparison between a measured RSRP and a reported RSRP, according to an aspect.

In FIG. 4, the measured RSRP 402, in dBm, is illustrated along the horizontal axis and the reported RSRP 404, in dBm, is illustrated along the vertical axis. A first line 406 represents the RSRP that is reported when the UE transmit power is not reduced (e.g., without proximity detection). A second line 408 represents the RSRP that is reported when the UE transmit power is reduced (e.g., with proximity detection).

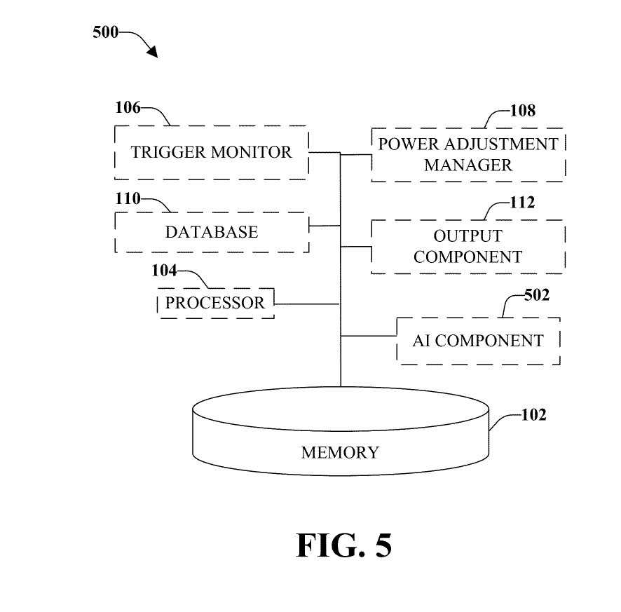

FIG. 5 illustrates an example, non-limiting system 500 that employs an artificial intelligence (AI) component 502, which can facilitate automating one or more features in accordance with the disclosed aspects. A memory 102, a processor 104, a trigger monitor 106, a power adjustment manager 108, a database 110, and an output component 112, as well as other components (not illustrated) can include functionality, as more fully described herein, for example, with regard to the previous figures. The disclosed aspects in connection with preserving communications during uplink power limitation situations can employ various AI-based schemes for carrying out various aspects thereof. For example, a process for detecting one or more trigger events, reducing an output power as a result of the one or more trigger events, and modifying one or more reported measurements, and so forth, can be facilitated with an example automatic classifier system and process. In another example, a process for penalizing one frequency/technology while preferring another frequency/technology can be facilitated with the example automatic classifier system and process.

An example classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that can be automatically performed. In the case of communication systems, for example, attributes can be a frequency band and a technology and the classes can be an output power reduction value. In another example, the attributes can be a frequency band, a technology, and the presence of an object and the classes can be an output power reduction value.

A support vector machine (SVM) is an example of a classifier that can be employed. The SVM can operate by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, for example, naïve Bayes, Bayesian networks, decision trees, neural networks, fuzzy logic models, and probabilistic classification models providing different patterns of independence can be employed. Classification as used herein also may be inclusive of statistical regression that is utilized to develop models of priority.

The disclosed aspects can employ classifiers that are explicitly trained (e.g., via a generic training data) as well as implicitly trained (e.g., via observing mobile device usage as it relates to triggering events, observing network frequency/technology, receiving extrinsic information, and so on). For example, SVMs can be configured via a learning or training phase within a classifier constructor and feature selection module. Thus, the classifier(s) can be used to automatically learn and perform a number of functions, including but not limited to modifying a transmit power, modifying one or more reported mobility measurements, and so forth. The criteria can include, but is not limited to, predefined values, frequency attenuation tables or other parameters, service provider preferences and/or policies, and so on.

In view of the example systems shown and described herein, methods that may be implemented in accordance with the one or more of the disclosed aspects, will be better understood with reference to the following flow charts. While, for purposes of simplicity of explanation, the methods are shown and described as a series of blocks, it is to be understood that the disclosed aspects are not limited by the number or order of blocks, as some blocks may occur in different orders and/or at substantially the same time with other blocks from what is depicted and described herein. Moreover, not all illustrated blocks may be required to implement the methods described hereinafter. It is noted that the functionality associated with the blocks may be implemented by software, hardware, a combination thereof or any other suitable means (e.g. device, system, process, component). Additionally, it is also noted that the methods disclosed hereinafter and throughout this specification are capable of being stored on an article of manufacture to facilitate transporting and transferring such methodologies to various devices. Those skilled in the art will understand that a method could alternatively be represented as a series of interrelated states or events, such as in a state diagram. The various methods disclosed herein can be performed by a system comprising at least one processor.

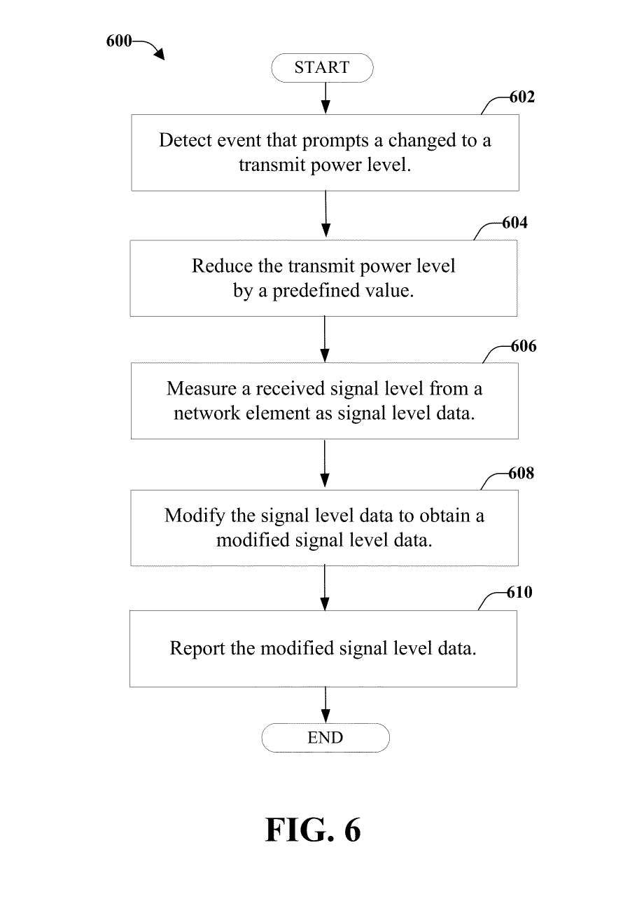

FIG. 6 illustrates an example, non-limiting method 600 for adaptive layer selection by a power limited device, according to an aspect. In some cases, a transmit power of a mobile device is reduced (e.g., to conform with SAR exposure limits). However, the base station is not aware that the transmit power of the mobile device has been reduced and, therefore, cannot make any adjustments or modifications to compensate for the reduction. Method 600 can be configured to help ensure a balanced RF communication path between the mobile device and the base station during power limiting events.

At 602, an event that prompts a change to a transmit power level of a mobile device is detected. For example, the event can be the presence of a body or another object in close proximity to the mobile device. However, the event can be another situation that prompts the need to reduce the transmit power level of the mobile device. The event can be detected when the device is in an active mode and/or in an idle mode.

As a result of detection of the event, at 604, a transmit power level of the mobile device is reduced by a predefined value. In an implementation, the transmit power level of the mobile device can be reduced as a function of a frequency band in which the mobile device is determined to be operating and a type of technology the mobile device is configured to employ. According to some implementations, reducing the transmit power level of the mobile device comprises accessing a frequency attenuation table, which can be stored on the mobile device.

A received signal level from a network element is measured, at 606. The received signal level from the network element can be measured as signal level data. The signal level data representing the received signal level measured is modified, at 608, to obtain modified signal level data representing the received signal level as modified. The modification to the signal level data can include reducing the measured value by the predefined value (e.g., the same value by which the transmit power level of the mobile device is reduced). According to an implementation, modifying the signal level data representing the received signal level comprises balancing a link budget equation.

The modified signal level data can be reported to the network element or another component of the network, at 610. In an implementation, the modified signal level data is reported to a network device that manages storage of measurements related to handover (re)selection from a first frequency technology layer to a second frequency technology layer (e.g., mobility). In an additional or alternative implementation, the signal level data (e.g., the measured level before any modifications) is reported for measurements related to open loop power control (e.g., non-mobility). According to some implementations, the signal level data representing the received signal level is reported in response to determining that the transmit power level of the mobile device has not been reduced.

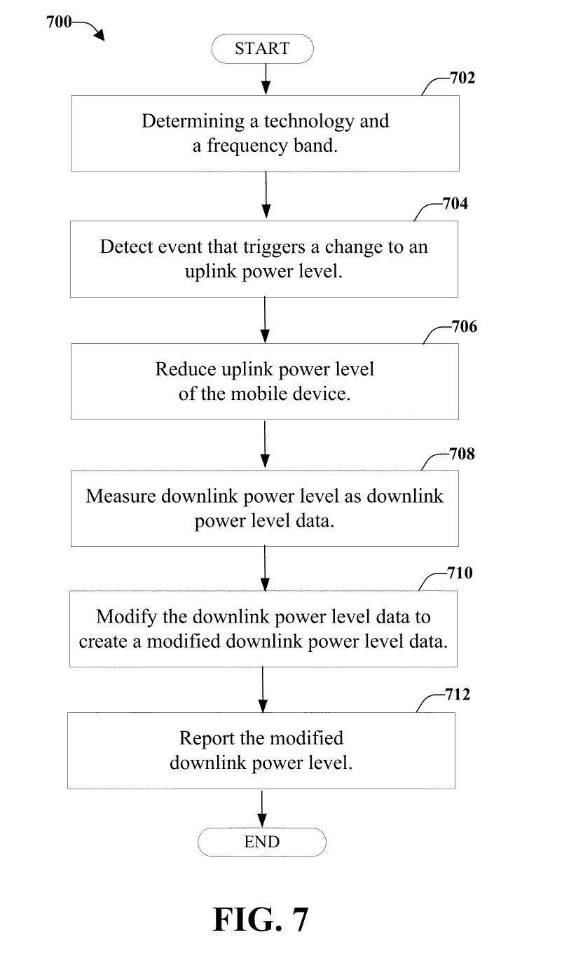

FIG. 7 illustrates an example, non-limiting method 700 for considering uplink power limitations to mitigate communication failures, according to an aspect. Method 700 starts, at 702, with determination of a technology employed by a device and a frequency band in which a device is operating. The technology and frequency band can be, for example, LTE 700, LTE AWS, LTE 850, LTE 1900, UMTS 850, UMTS 1900, and so forth. It is noted that although LTE and UMTS are used herein as examples, the disclosed aspects are not limited to an LTE or UMTS implementation.

At 704, an event that triggers a change to an uplink power level is detected. For example, the event can be detected through the usage of one or more proximity sensors that are configured to detect when a body or another object is near (e.g., within a defined proximity of) the mobile device. In an example, the body can have predetermined human characteristics. At 706, the uplink power level of the mobile device is reduced by a defined value in response to detecting the event. For example, when a body is near the mobile device, the uplink power level can be reduced in order to conform with SAR exposure limits. According to an implementation, the uplink power level can be reduced by a predefined amount that is determined based on the technology and the frequency band.

In accordance with some aspects, reducing the uplink power level includes accessing a frequency attenuation table and using the frequency attenuation table to determine the defined value. The defined value can be a function of the technology and the frequency band. For example, the frequency attenuation table can include a cross reference to each technology and frequency band compared to the amount that the measured uplink power level should be reduced if, for example, a proximity sensor is triggered.

At 708, a downlink power level is measured as downlink power level data. If the uplink power level of the mobile device is reduced (at 706), the downlink power level data representing the downlink power level is modified, at 710. The amount that the downlink power level is modified by is the defined value (e.g., the same value as the uplink power level was reduced by). The result of the modification is to obtain modified downlink power level data representing the downlink power level as modified. For example, if the measured uplink power level is reduced by 7 dB, the downlink power level measurement is reduced by 7 dB. According to an implementation, modifying the downlink power level comprises balancing a link budget equation.

The modified downlink power level data is reported, at 710, to facilitate mobility measurements made by a network device. For example, the modified downlink power level data can be reported to the base station serving the mobile device. In an implementation, the downlink power level data (e.g., the actual measured value) is reported to the base station (or other network device) to facilitate non-mobility measurements by the base station (or other network device).

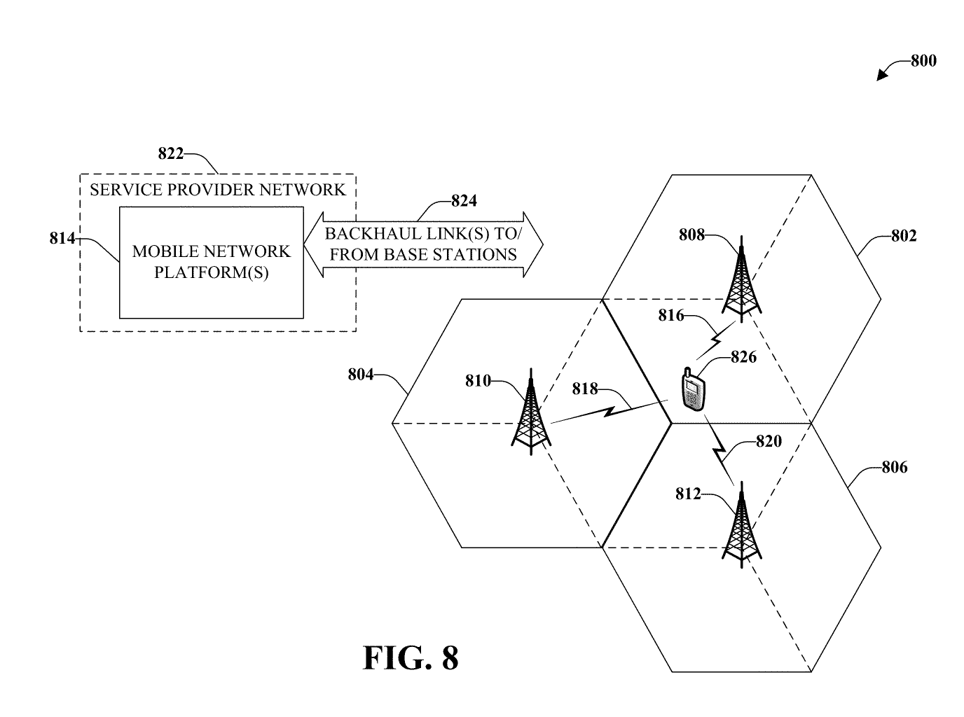

By way of further description with respect to one or more non-limiting ways to compensate for reductions in transmit power, FIG. 8 is a schematic example wireless environment 800 that can operate in accordance with aspects described herein. In particular, example wireless environment 800 illustrates a set of wireless network macro cells. Three coverage macro cells 802, 804, and 806 include the illustrative wireless environment; however, it is noted that wireless cellular network deployments can encompass any number of macro cells. Coverage macro cells 802, 804, and 806 are illustrated as hexagons; however, coverage cells can adopt other geometries generally dictated by a deployment configuration or floor plan, geographic areas to be covered, and so on. Each macro cell 802, 804, and 806 is sectorized in a 2π/3 configuration in which each macro cell includes three sectors, demarcated with dashed lines in FIG. 8. It is noted that other sectorizations are possible, and aspects or features of the disclosed subject matter can be exploited regardless of type of sectorization. Macro cells 802, 804, and 806 are served respectively through base stations or eNodeBs 808, 810, and 812. Any two eNodeBs can be considered an eNodeB site pair (NBSP). It is noted that radio component(s) are functionally coupled through links such as cables (e.g., RF and microwave coaxial lines), ports, switches, connectors, and the like, to a set of one or more antennas that transmit and receive wireless signals (not illustrated). It is noted that a radio network controller (not shown), which can be a part of mobile network platform(s) 814, and set of base stations (e.g., eNodeB 808, 810, and 812) that serve a set of macro cells; electronic circuitry or components associated with the base stations in the set of base stations; a set of respective wireless links (e.g., links 816, 818, and 820) operated in accordance to a radio technology through the base stations, form a macro radio access network (RAN). It is further noted that, based on network features, the radio controller can be distributed among the set of base stations or associated radio equipment. In an aspect, for UMTS-based networks, wireless links 816, 818, and 820 embody a Uu interface (UMTS Air Interface).

Mobile network platform(s) 814 facilitates circuit switched (CS)-based (e.g., voice and data) and packet-switched (PS) (e.g., internet protocol (IP), frame relay, or asynchronous transfer mode (ATM)) traffic and signaling generation, as well as delivery and reception for networked telecommunication, in accordance with various radio technologies for disparate markets. Telecommunication is based at least in part on standardized protocols for communication determined by a radio technology utilized for communication. In addition, telecommunication can exploit various frequency bands, or carriers, which include any EM frequency bands licensed by the service provider network 822 (e.g., personal communication services (PCS), advanced wireless services (AWS), general wireless communications service (GWCS), and so forth), and any unlicensed frequency bands currently available for telecommunication (e.g., the 2.4 GHz industrial, medical and scientific (IMS) band or one or more of the 5 GHz set of bands). In addition, mobile network platform(s) 814 can control and manage base stations 808, 810, and 812 and radio component(s) associated thereof, in disparate macro cells 802, 804, and 806 by way of, for example, a wireless network management component (e.g., radio network controller(s), cellular gateway node(s), etc.) Moreover, wireless network platform(s) can integrate disparate networks (e.g., femto network(s), Wi-Fi network(s), femto cell network(s), broadband network(s), service network(s), enterprise network(s), and so on). In cellular wireless technologies (e.g., 3rd Generation Partnership Project (3GPP) Universal Mobile Telecommunication System (UMTS), Global System for Mobile Communication (GSM)), mobile network platform 814 can be embodied in the service provider network 822.

In addition, wireless backhaul link(s) 824 can include wired link components such as T1/E1 phone line; a digital subscriber line (DSL) either synchronous or asynchronous; an asymmetric DSL (ADSL); an optical fiber backbone; a coaxial cable, etc.; and wireless link components such as line-of-sight (LOS) or non-LOS links which can include terrestrial air-interfaces or deep space links (e.g., satellite communication links for navigation). In an aspect, for UMTS-based networks, wireless backhaul link(s) 824 embodies IuB interface.

It is noted that while exemplary wireless environment 800 is illustrated for macro cells and macro base stations, aspects, features and advantages of the disclosed subject matter can be implemented in microcells, picocells, femto cells, or the like, wherein base stations are embodied in home-based equipment related to access to a network.

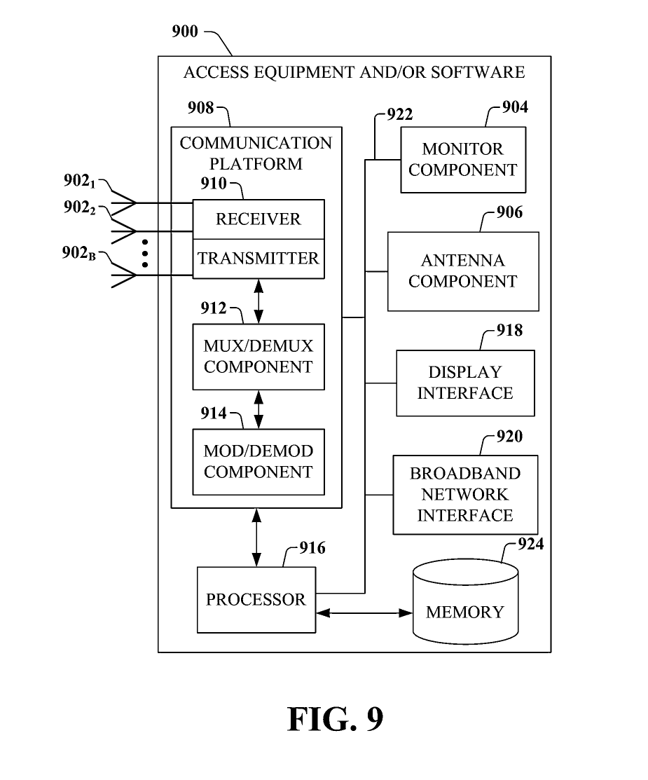

To provide further context for various aspects of the disclosed subject matter, FIG. 9 illustrates a block diagram of an embodiment of access equipment and/or software 900 related to access of a network (e.g., base station, wireless access point, femtocell access point, and so forth) that can enable and/or exploit features or aspects of the disclosed aspects.

Access equipment and/or software 900 related to access of a network can receive and transmit signal(s) from and to wireless devices, wireless ports, wireless routers, etc. through segments 902₁-902_{B} (B is a positive integer). Segments 902₁-902ₐ can be internal and/or external to access equipment and/or software 900 related to access of a network, and can be controlled by a monitor component 904 and an antenna component 906. Monitor component 904 and antenna component 906 can couple to communication platform 908, which can include electronic components and associated circuitry that provide for processing and manipulation of received signal(s) and other signal(s) to be transmitted.

In an aspect, communication platform 908 includes a receiver/transmitter 910 that can convert analog signals to digital signals upon reception of the analog signals, and can convert digital signals to analog signals upon transmission. In addition, receiver/transmitter 910 can divide a single data stream into multiple, parallel data streams, or perform the reciprocal operation. Coupled to receiver/transmitter 910 can be a multiplexer/demultiplexer 912 that can facilitate manipulation of signals in time and frequency space. Multiplexer/demultiplexer 912 can multiplex information (data/traffic and control/signaling) according to various multiplexing schemes such as time division multiplexing (TDM), frequency division multiplexing (FDM), orthogonal frequency division multiplexing (OFDM), code division multiplexing (CDM), space division multiplexing (SDM). In addition, multiplexer/demultiplexer component 912 can scramble and spread information (e.g., codes, according to substantially any code known in the art, such as Hadamard-Walsh codes, Baker codes, Kasami codes, polyphase codes, and so forth).

A modulator/demodulator 914 is also a part of communication platform 908, and can modulate information according to multiple modulation techniques, such as frequency modulation, amplitude modulation (e.g., M-ary quadrature amplitude modulation (QAM), with M a positive integer); phase-shift keying (PSK); and so forth).

Access equipment and/or software 900 related to access of a network also includes a processor 916 configured to confer, at least in part, functionality to substantially any electronic component in access equipment and/or software 900. In particular, processor 916 can facilitate configuration of access equipment and/or software 900 through, for example, monitor component 904, antenna component 906, and one or more components therein. Additionally, access equipment and/or software 900 can include display interface 918, which can display functions that control functionality of access equipment and/or software 900, or reveal operation conditions thereof. In addition, display interface 918 can include a screen to convey information to an end user. In an aspect, display interface 918 can be an LCD (Liquid Crystal Display), a plasma panel, a monolithic thin-film based electrochromic display, and so on. Moreover, display interface 918 can include a component (e.g., speaker) that facilitates communication of aural indicia, which can also be employed in connection with messages that convey operational instructions to an end user. Display interface 918 can also facilitate data entry (e.g., through a linked keypad or through touch gestures), which can cause access equipment and/or software 900 to receive external commands (e.g., restart operation).

Broadband network interface 920 facilitates connection of access equipment and/or software 900 to a service provider network (not shown) that can include one or more cellular technologies (e.g., 3GPP UMTS, GSM, and so on.) through backhaul link(s) (not shown), which enable incoming and outgoing data flow. Broadband network interface 920 can be internal or external to access equipment and/or software 900, and can utilize display interface 918 for end-user interaction and status information delivery.

Processor 916 can be functionally connected to communication platform 908 and can facilitate operations on data (e.g., symbols, bits, or chips) for multiplexing/demultiplexing, such as effecting direct and inverse fast Fourier transforms, selection of modulation rates, selection of data packet formats, inter-packet times, and so on. Moreover, processor 916 can be functionally connected, through data, system, or an address bus 922, to display interface 918 and broadband network interface 920, to confer, at least in part, functionality to each of such components.

In access equipment and/or software 900, memory 924 can retain location and/or coverage area (e.g., macro sector, identifier(s)), access list(s) that authorize access to wireless coverage through access equipment and/or software 900, sector intelligence that can include ranking of coverage areas in the wireless environment of access equipment and/or software 900, radio link quality and strength associated therewith, or the like. Memory 924 also can store data structures, code instructions and program modules, system or device information, code sequences for scrambling, spreading and pilot transmission, access point configuration, and so on. Processor 916 can be coupled (e.g., through a memory bus), to memory 924 in order to store and retrieve information used to operate and/or confer functionality to the components, platform, and interface that reside within access equipment and/or software 900.

As it employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” data storage,” “database,” and substantially any other information storage component relevant to operation and functionality of a component and/or process, refer to “memory components,” or entities embodied in a “memory,” or components including the memory. It is noted that the memory components described herein can be either volatile memory or nonvolatile memory, or can include both volatile and nonvolatile memory.

By way of illustration, and not limitation, nonvolatile memory, for example, can be included in memory 924, non-volatile memory (see below), disk storage (see below), and memory storage (see below). Further, nonvolatile memory can be included in read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to include, without being limited to including, these and any other suitable types of memory.

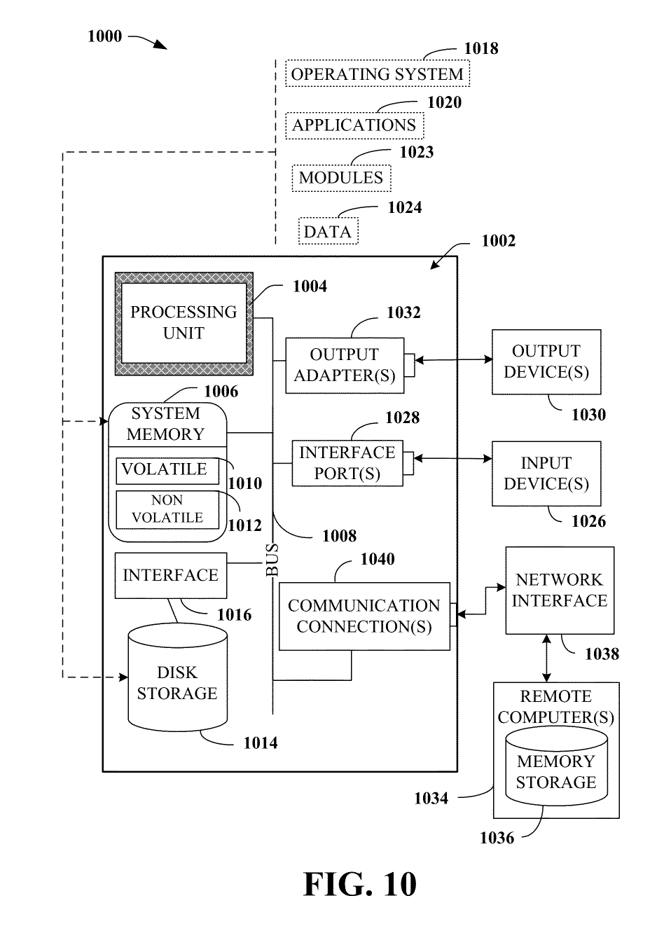

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the various aspects also can be implemented in combination with other program modules. Generally, program modules include routines, programs, components, data structures, etc. that perform particular tasks and/or implement particular abstract data types. For example, in memory (such as memory 102) there can be software, which can instruct a processor (such as processor 104) to perform various actions. The processor can be configured to execute the instructions in order to implement the analysis of monitoring an uplink power level, detecting the uplink power level is at or above a threshold level, and/or disable transmission of at least one message as a result of the monitored uplink power level.

Moreover, those skilled in the art will understand that the various aspects can be practiced with other computer system configurations, including single-processor or multiprocessor computer systems, mini-computing devices, mainframe computers, as well as personal computers, base stations hand-held computing devices or user equipment, such as a PDA, phone, watch, and so forth, processor-based computers/systems, microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

With reference to FIG. 10, a block diagram of a computing system 1000 operable to execute the disclosed systems and methods is illustrated, in accordance with an embodiment. Computer 1002 includes a processing unit 1004, a system memory 1006, and a system bus 1008. System bus 1008 couples system components including, but not limited to, system memory 1006 to processing unit 1004. Processing unit 1004 can be any of various available processors. Dual microprocessors and other multiprocessor architectures also can be employed as processing unit 1004.

System bus 1008 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1194), and Small Computer Systems Interface (SCSI).

System memory 1006 includes volatile memory 1010 and nonvolatile memory 1012. A basic input/output system (BIOS), containing routines to transfer information between elements within computer 1002, such as during start-up, can be stored in nonvolatile memory 1012. By way of illustration, and not limitation, nonvolatile memory 1012 can include ROM, PROM, EPROM, EEPROM, or flash memory. Volatile memory 1010 can include RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1002 also includes removable/non-removable, volatile/non-volatile computer storage media. In an implementation, provided is a non-transitory or tangible computer-readable medium storing computer-executable instructions that, in response to execution, cause a system including a processor to perform operations. The operations can include detecting a presence of a body having predetermined human characteristics within a defined proximity of a mobile device. The presence of the body can prompt a change to a transmit power level of the mobile device. The operations can also include reducing the transmit power level of the mobile device by a predefined value as a result of detecting the presence of the body. According to an aspect, the predefined value can be determined based on a technology to be employed by the mobile device and a frequency band with which the mobile device communicates with for a network associated with operation of the mobile device. Further, the operations can include determining signal level data by measuring a signal level of a signal received from the network, modifying the signal level data by subtracting the predefined value to obtain modified signal level data, and reporting the modified signal level data to the network.

In an implementation, the operations can include reporting the signal level data based on a determination that the presence of the body has not been detected. According to another implementation, the operations can include reporting the modified signal level data to a network device to facilitate handover selection. In accordance with another implementation, the operations can include reporting the signal level data to a network device to facilitate open loop power control.

FIG. 10 illustrates, for example, disk storage 1014. Disk storage 1014 includes, but is not limited to, devices such as a magnetic disk drive, floppy disk drive, tape drive, Jaz drive, Zip drive, LS-100 drive, flash memory card, or memory stick. In addition, disk storage 1014 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1014 to system bus 1008, a removable or non-removable interface is typically used, such as interface component 1016.

It is to be noted that FIG. 10 describes software that acts as an intermediary between users and computer resources described in suitable operating environment. Such software includes an operating system 1018. Operating system 1018, which can be stored on disk storage 1014, acts to control and allocate resources of computer system 1002. System applications 1020 can take advantage of the management of resources by operating system 1018 through program modules 1022 and program data 1024 stored either in system memory 1006 or on disk storage 1014. It is to be understood that the disclosed subject matter can be implemented with various operating systems or combinations of operating systems.

A user can enter commands or information, for example through interface component 1016, into computer system 1002 through input device(s) 1026. Input devices 1026 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to processing unit 1004 through system bus 1008 through interface port(s) 1028. Interface port(s) 1028 include, for example, a serial port, a parallel port, a game port, and a universal serial bus (USB). Output device(s) 1030 use some of the same type of ports as input device(s) 1026.

Thus, for example, a USB port can be used to provide input to computer 1002 and to output information from computer 1002 to an output device 1030. Output adapter 1032 is provided to illustrate that there are some output devices 1030, such as monitors, speakers, and printers, among other output devices 1030, which use special adapters. Output adapters 1032 include, by way of illustration and not limitation, video and sound cards that provide means of connection between output device 1030 and system bus 1008. It is also noted that other devices and/or systems of devices provide both input and output capabilities such as remote computer(s) 1034.

Computer 1002 can operate in a networked environment using logical connections to one or more remote computers, such as remote computer(s) 1034. Remote computer(s) 1034 can be a personal computer, a server, a router, a network PC, a workstation, a microprocessor based appliance, a peer device, or other common network node and the like, and typically includes many or all of the elements described relative to computer 1002.

For purposes of brevity, only one memory storage device 1036 is illustrated with remote computer(s) 1034. Remote computer(s) 1034 is logically connected to computer 1002 through a network interface 1038 and then physically connected through communication connection 1040. Network interface 1038 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1040 refer(s) to hardware/software employed to connect network interface 1038 to system bus 1008. While communication connection 1040 is shown for illustrative clarity inside computer 1002, it can also be external to computer 1002. The hardware/software for connection to network interface 1038 can include, for example, internal and external technologies such as modems, including regular telephone grade modems, cable modems and DSL modems, ISDN adapters, and Ethernet cards.

It is to be noted that aspects, features, or advantages of the aspects described in the subject specification can be exploited in substantially any communication technology. For example, 4G technologies, Wi-Fi, WiMAX, Enhanced GPRS, 3GPP LTE, 3GPP2 UMB, 3GPP UMTS, HSPA, HSDPA, HSUPA, GERAN, UTRAN, LTE Advanced. Additionally, substantially all aspects disclosed herein can be exploited in legacy telecommunication technologies; e.g., GSM. In addition, mobile as well non-mobile networks (e.g., Internet, data service network such as IPTV) can exploit aspect or features described herein.

Various aspects or features described herein can be implemented as a method, apparatus, or article of manufacture using standard programming and/or engineering techniques. In addition, various aspects disclosed in the subject specification can also be implemented through program modules stored in a memory and executed by a processor, or other combination of hardware and software, or hardware and firmware.

Other combinations of hardware and software or hardware and firmware can enable or implement aspects described herein, including disclosed method(s). The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical discs (e.g., compact disc (CD), digital versatile disc (DVD), blu-ray disc (BD) . . . ), smart cards, and flash memory devices (e.g., card, stick, key drive . . . ).

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

What has been described above includes examples of systems and methods that provide advantages of the one or more aspects. It is, of course, not possible to describe every conceivable combination of components or methods for purposes of describing the aspects, but one of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

As used in this application, the terms “component,” “system,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration, both an application running on a server or network controller, and the server or network controller can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software, or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components. As further yet another example, interface(s) can include input/output (I/O) components as well as associated processor, application, or Application Programming Interface (API) components.

The term “set”, “subset”, or the like as employed herein excludes the empty set (e.g., the set with no elements therein). Thus, a “set”, “subset”, or the like includes one or more elements or periods, for example. As an illustration, a set of periods includes one or more periods; a set of transmissions includes one or more transmissions; a set of resources includes one or more resources; a set of messages includes one or more messages, and so forth.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

What is claimed is:

1. A system comprising:
a memory to store computer-executable instructions; and
a processor, communicatively coupled to the memory, that facilitates execution of the computer-executable instructions to perform operations, comprising:
reducing a transmit power level of a mobile device by a predefined value as a result of detecting an event associated with a change to the transmit power level;
measuring a received signal level of a signal received from a network element as signal level data;
modifying the signal level data representing the received signal level based on the predefined value to obtain modified signal level data representing the received signal level as modified; and
reporting the modified signal level data to the network element.

2. The system of claim 1, wherein the operations further comprise reporting the modified signal level data to a network device that manages storage of measurements related to handover selection from a first frequency technology layer to a second frequency technology layer.

3. The system of claim 1, wherein the operations further comprise reporting the signal level data for measurements related to open loop power control.

4. The system of claim 1, wherein the reducing the transmit power level of the mobile device comprises reducing the transmit power level of the mobile device as a function of a frequency band in which the mobile device is determined to be operating and a type of radio access technology being utilized by the mobile device.

5. The system of claim 1, wherein the operations further comprise detecting the event, wherein the detecting the event comprises detecting an object is in close proximity to the mobile device.

6. The system of claim 1, wherein the reducing the transmit power level of the mobile device comprises accessing a frequency attenuation table.

7. The system of claim 1, wherein the operations further comprise reporting the signal level data representing the received signal level in response to determining that the transmit power level of the mobile device has not been reduced.

8. The system of claim 7, wherein the modifying the signal level data representing the received signal level comprises balancing a link budget equation.

9. The system of claim 1, wherein the operations further comprise detecting the event, wherein the detecting the event comprises detecting the event based on a determination that the mobile device is in an active mode.

10. The system of claim 1, wherein the operations further comprise detecting the event, wherein the detecting the event comprises detecting the event based on a determination that the mobile device is in an idle mode.

11. A method, comprising:
determining, by a device comprising a processor, a radio access technology employed by the device and a frequency band in which the device is operating;
detecting, by the device, an event that triggers a change to an uplink power level of the device;
reducing, by the device, the uplink power level by a defined value in response to the detecting the event;
measuring, by the device, a downlink power level received by the device as downlink power level data;
modifying, by the device, the downlink power level data representing the downlink power level by the defined value to obtain modified downlink power level data representing the downlink power level as modified; and
reporting, by the device, the modified downlink power level data to facilitate mobility measurements made by a network device.

12. The method of claim 11, further comprising:
reporting, by the device, the downlink power level data to facilitate non-mobility measurements made by the network device.

13. The method of claim 11, wherein the detecting comprises using a proximity sensor to detect a presence of an object, wherein detection of the presence of the object is the event that triggers the change to the uplink power level.

14. The method of claim 11, further comprising:
determining, by the device, the defined value based on the radio access technology and the frequency band.

15. The method of claim 11, wherein the reducing the uplink power level comprises:
accessing a frequency attenuation table; and
using the frequency attenuation table to determine the defined value, wherein the defined value is a function of the radio access technology and the frequency band.

16. The method of claim 11, wherein the modifying the downlink power level data comprises balancing a link budget equation.

17. A tangible computer-readable medium storing computer-executable instructions that, in response to execution, cause a system including a processor to perform operations, comprising:
detecting a presence of a body having human characteristics within a defined proximity of a mobile device, wherein the presence of the body prompts a change to a transmit power level of the mobile device;
reducing the transmit power level of the mobile device by a predefined value as a result of the detecting the presence of the body, wherein the predefined value is determined based on a radio access technology determined to be employed by the mobile device and a frequency band with which the mobile device communicates with a network associated with operation of the mobile device;
determining signal level data by measuring a signal level of a signal received from the network;
modifying the signal level data by subtracting the predefined value to obtain modified signal level data; and
reporting the modified signal level data to the network.

18. The tangible computer-readable medium of claim 17, wherein the operations further comprise reporting the signal level data based on a determination that the presence of the body has not been detected.

19. The tangible computer-readable medium of claim 17, wherein the operations further comprise reporting the modified signal level data to a network device to facilitate handover selection.

20. The tangible computer-readable medium of claim 17, wherein the operations further comprise reporting the signal level data to a network device to facilitate open loop power control.
